(19) United States
(12) Patent Application Publication
(10) Pub. No.: US 2017/0089627 A1
(43) Pub. Date: Mar. 30, 2017

(54) CHILLER

(71) Applicant: LG ELECTRONICS INC., Seoul (KR)

(72) Inventors: Jonggyu LEE, Seoul (KR); Hyejeong Shin, Seoul (KR)

(21) Appl. No.: 15/274,033

(22) Filed: Sep. 23, 2016

(30) Foreign Application Priority Data
Sep. 24, 2015 (KR) 10-2015-0135764

(51) Int. Cl. F25B 49/02; H02P 21/24; H02P 27/08; F25B 25/00; F25B 1/10

(52) U.S. Cl. CPC F25B 49/025; F25B 25/005; F25B 1/10; H02P 27/08; H02P 21/24; F25B 2339/047; F25B 2700/151; F25B 2700/15

(57) ABSTRACT

A chiller is provided that may include a plurality of compressors, a plurality of drives to drive the plurality of compressors, an input having a plurality of switches, to which IDs that correspond to the plurality of drives are assigned, and a controller to control the plurality of drives. When one or more of the switches is turned on, the controller may perform control to first operate a drive of the plurality of drives which corresponds to a switch having a smallest ID number, among turned-on switches. Thereby, when the plurality of switches is turned on, the plurality of compressors may be efficiently and stably driven.

### CROSS-REFERENCE TO RELATED APPLICATION

This application claims priority under 35 U.S.C. §119 to Korean Patent Application No. 10-2015-0135764, filed in Korea on Sep. 24, 2015, whose entire disclosure is hereby incorporated by reference.

### BACKGROUND

1. Field

A chiller is disclosed herein.

2. Background

An air conditioner is an apparatus that discharges cold air into a room in order to make a pleasant room environment. Such an air conditioner is installed or provided to provide humans with a more pleasant room environment by adjusting a room temperature and purifying room air. Generally, such an air conditioner includes an indoor unit or device, which includes a heat exchanger and is installed or provided in a room, and an outdoor unit or device, which includes a compressor and a heat exchanger, for example, and supplies refrigerant to the indoor unit.

As an example of the air conditioner, a chiller is used in a place of business which is larger than a home, or a building, for example. Generally, the chiller includes a cooling tower installed or provided on an outdoor rooftop, and a heat exchange unit or heat exchanger configured to circulate refrigerant for heat exchange between the refrigerant and cooling water transferred from the cooling tower. In addition, the heat exchanger includes a compressor, a condenser, and an evaporator.

### BRIEF DESCRIPTION OF THE DRAWINGS

Embodiments will be described in detail with reference to the following drawings in which like reference numerals refer to like elements, and wherein:

FIG. 1 is a schematic diagram of a chiller according to an embodiment;

FIG. 2 is a schematic diagram of an air conditioner of FIG. 1;

FIG. 3 is an internal block diagram of the chiller in FIG. 1;

FIG. 4 is an internal block diagram of a motor-driving apparatus in FIG. 3;

FIG. 5 is an internal circuit diagram of the motor-driving apparatus in FIG. 4;

FIG. 6 is an internal block diagram of an inverter controller in FIG. 5;

FIG. 7 is a view illustrating a plurality of drives;

FIG. 8 illustrates an example of an input in FIG. 3;

FIG. 9 is a flowchart illustrating a method of operating a chiller according to an embodiment; and

FIGS. 10 to 12 are views referenced to explain the method of FIG. 9.

### DETAILED DESCRIPTION

Hereinafter, embodiments will be described in detail with reference to the drawings. Where possible, like reference numerals have been used to indicate like elements, and repetitive disclosure has been omitted.

With respect to constituent elements used in the following description, suffixes “module” and “unit” are given or mingled with each other only in consideration of ease in the preparation of the specification, and do not have or serve as different meanings. Accordingly, the terms “module” and “unit” may be used interchangeably.

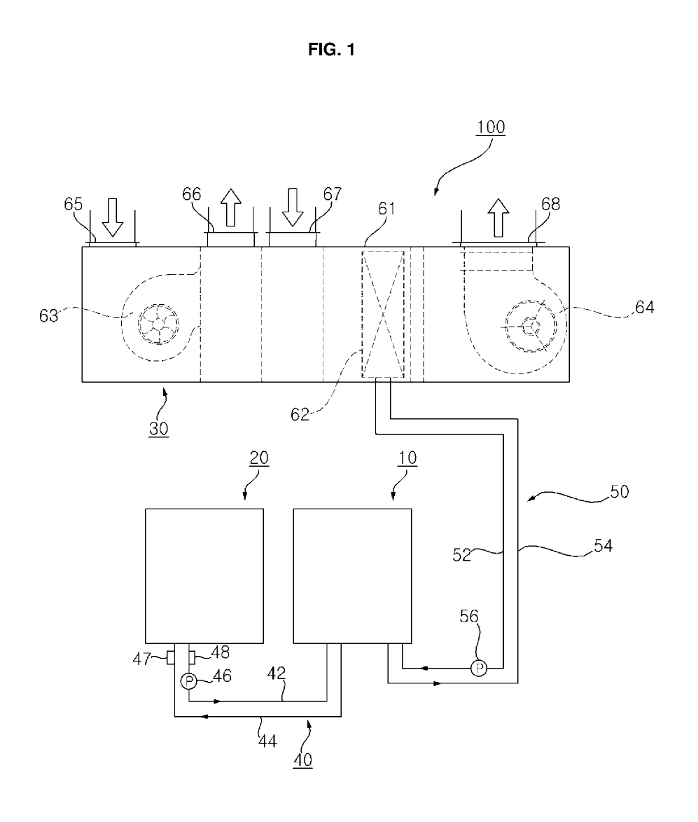

FIG. 1 is a schematic diagram of a chiller according to an embodiment. Referring to FIG. 1, the chiller 100 may include an air conditioning unit or air conditioner 10 provided with a refrigeration cycle, a cooling tower 20 that supplies cooling water to the air conditioner 10, and a cold-water-requiring place 30, through which cold water to undergo heat exchange with the air conditioner 10 may circulate. The cold-water-requiring place 30 may correspond to a device or space that performs air conditioning using cold water.

A circulation path 40, in which cooling water may flow, may be installed or provided between the air conditioner 10 and the cooling tower 20 so that the cooling water may circulate therebetween. The cooling water circulation path 40 may include a cooling water introduction path 42 that guides cooling water so as to introduce the same into the air conditioner 10, for example, a condenser, and a cooling water discharge path 44 that guides cooling water heated in the air conditioner 10 so as to move the same to the cooling tower 20.

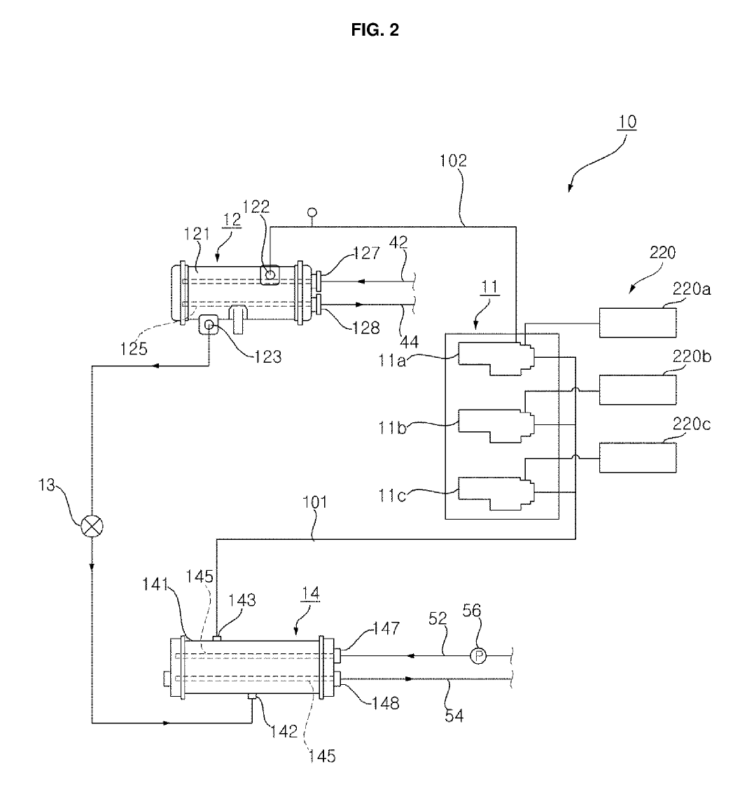

A cooling water pump 46 for the flow of cooling water may be provided in at least one of the cooling water introduction path 42 or the cooling water discharge path 44. FIG. 2 illustrates the cooling water pump 46 installed or provided in the cooling water introduction path 42, for example.

A discharge temperature sensor 47 that senses a temperature of the cooling water to be introduced into the cooling tower 20 may be installed or provided in the cooling water discharge path 44. In addition, an introduction temperature sensor 48 that measures a temperature of cooling water discharged from the cooling tower 20 may be installed or provided in the cooling water introduction path 42.

A cold water circulation path 50 may be installed or provided between the air conditioner 10 and the cold-water-requiring place 30 so that cooling water may circulate therebetween. The cold water circulation path 50 may include a cold water introduction path 52 that guides cold water so as to circulate the same between the cold-water-requiring place 30 and the air conditioner 10, and a cold water discharge path 54 that guides cold water cooled in the air conditioner 10 so as to move the same to the cold-water-requiring place 30.

A cold water pump 56 that circulates the cold water may be provided in at least one of the cold water introduction path 52 or the cold water discharge path 54. FIG. 2 illustrates the cold water pump 56 installed or provided in the cold water introduction path 52, for example.

In this embodiment, the cold-water-requiring place 30 is described as a water-cooled air conditioner that performs heat exchange between air and cold water. For example, the cold-water-requiring place 30 may include at least one unit or device among an Air-Handing Unit (AHU) or air handler, which mixes indoor air and outdoor air, and thereafter performs heat exchange between the mixed air and cold water so as to introduce the heat-exchanged air into a room, a Fan Coil Unit (FCU) or fan coil, which is installed or provided in a room and performs heat exchange between indoor air and cold water and then discharges the heat-exchanged air into the room, and a floor pipe unit or floor pipe buried in a floor of a room. FIG. 2 illustrates the cold-water-requiring place 30 configured as an air handling unit, for example.

The cold-air-requiring place 30 may include a casing 61, a cold water coil 62 installed or provided in the casing 61 to allow cold water to pass therethrough, and blowers 63 and 64 provided at opposite sides of the cold water coil 62 to suction indoor air and outdoor air and to blow conditioned air into a room. More specifically, the blowers may include a first blower 63 that suctions indoor air and outdoor air into the casing 61 and a second blower 64 that discharges the conditioned air from the casing 61.

The casing 61 may include an indoor air suction section or inlet 65, an indoor air discharge section or outlet 66, an outdoor air suction section or inlet 67, and a conditioned air discharge section or outlet 68. When the blowers 63 and 64 are driven, some of the air introduced into the indoor air suction section 65 may be discharged to the indoor air discharge section 66, and the remaining air may be mixed with outdoor air suctioned into the outdoor air suction section 67 and thereafter undergo heat exchange with the cold water while passing through the cold water coil 62. Thereafter, the heat-exchanged mixed air may be introduced into a room through the conditioned air discharge section 68.

FIG. 2 is a schematic diagram of the air conditioner in FIG. 1. Referring to FIG. 2, the air conditioner 10 may include a compressor 11 that compresses a refrigerant, a condenser 12, into which high-temperature and high-pressure refrigerant, compressed in the compressor 11, may be introduced, an expander 13 that decompresses the refrigerant condensed in the condenser 12, an evaporator 14 that evaporates the refrigerant decompressed in the expander 13, and a drive 220 that operates the compressor 11. The compressor 11 may include a plurality of compressors 11a, 11b, 11c. The air conditioner 10 may include a suction pipe 101 installed or provided at an entrance side of the compressor 11 that guides the refrigerant, discharged from the evaporator 14, to the compressor 11, and a discharge pipe 102 installed or provided at an exit side of the compressor 11 that guides the refrigerant, discharged from the compressor 11, to the condenser 12.

The condenser 12 and the evaporator 14 may be configured as a shell-and-tube heat exchangers that enable heat exchange between refrigerant and water. The condenser 12 may include a shell 121 that defines an external appearance of the condenser 12, an inlet port 122 installed or provided on or at one or a first side of the shell 121 for the introduction of refrigerant compressed in the plurality of compressors 11a, 11b and 11c, and an outlet port 123 installed or provided on an opposite or second side of the shell 121 for the discharge of the refrigerant condensed in the condenser 12.

In addition, the condenser 12 may include a cooling water pipe 125 that guides a flow of cooling water inside of the shell 121, an inlet portion or inlet 127 installed or provided at an end of the shell 121 to guide the cooling water, supplied from the cooling tower 20 through the introduction path 42, to an inside of the shell 121, and an outlet portion or outlet 128 installed or provided at the end of the shell 121 to discharge the cooling water from the condenser 12 so as to move the same to the cooling tower 20 through the discharge path 44. In the condenser 12, the cooling water may flow through the cooling water pipe 125, and undergo heat exchange with the refrigerant which has been introduced into the shell 121 through the inlet port 122.

The evaporator 14 may include a shell 141 that defines an external appearance of the evaporator 14, an inlet port 142 installed or provided on or at one or a first side of the shell 141 for the introduction of the refrigerant expanded in the evaporator 13, and an outlet port 143 installed or provided on an opposite or second side of the shell 141 for the discharge of the refrigerant, evaporated in the evaporator 14, to the compressor 11. The outlet port 143 may be connected to the suction pipe 101 so that the evaporated refrigerant may be transferred from the evaporator 14 to the compressor 11.

The evaporator 14 may include a cold water pipe 145 installed or provided inside of the shell 141 to guide the flow of the cold water, an inlet portion or inlet 147 installed or provided on or at one or a first side of the shell 141 to guide cold water to the cold water pipe 145, and an outlet portion or outlet 148 installed or provided on or at a same side as the inlet 147 to discharge the cold water circulated in the evaporator 14. The water introduction path 52 and the water discharge path 54 may be connected, respectively, to the inlet 147 and the outlet 148, which enables circulation of cold water between the air conditioner 10 and the cold water coil 62 of the cold-water-requiring place 30.

The drive 220 may include a plurality of drive units or drives 220a, 220b and 220c that drive the respective compressors 11a, 11b and 11c. Each of the plurality of drives 220a, 220b and 220c may include, for example, a converter and an inverter.

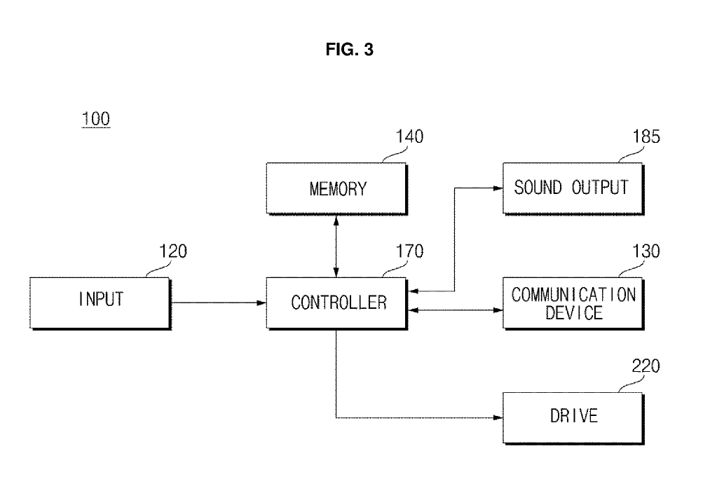

FIG. 3 is an internal block diagram of the chiller in FIG. 1. The chiller 100 may include an input unit or input 120, a communication unit or device 130, a memory 140, a controller 170, a sound output unit or output 185, and the drive 220.

The input 120 may include, for example, manipulation buttons and keys, and may output an input signal for a power-on/power-off of the chiller 100, or an operation setting, for example. In particular, the input 120 may include a plurality of switches, to which IDs corresponding to the plurality of drives 220a, 220b and 220c may be assigned, according to an embodiment.

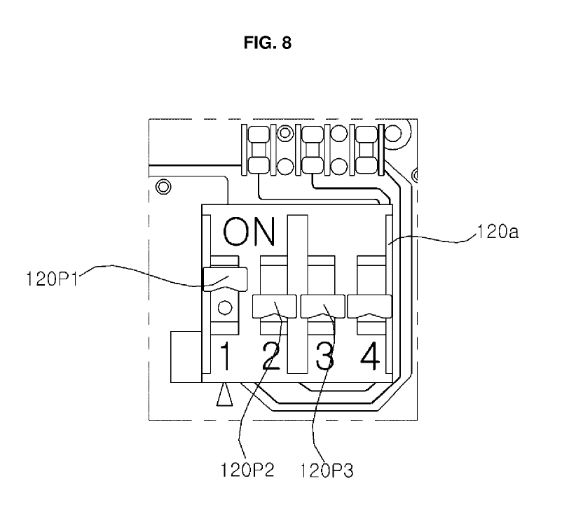

The switches may be hardware switches, such as dip switches or tact switches. For example, the switches may be first to third switches 120P1, 120P2 and 120P3 (see FIG. 8), to which IDs corresponding to the plurality of drives 220a, 220b and 220c may be assigned.

The communication device 130 may exchange data with a peripheral appliance, for example, a remote controller or a mobile terminal, in a wired or wireless manner. For example, the communication device 130 may perform Infrared (IR) communication, RF communication, Bluetooth communication, ZigBee communication, or Wi-Fi communication.

The memory 140 of the chiller 100 may store data required to operate the chiller 100. For example, the memory 140 may store data related to a time for which the drive 220 is operated and an operating mode. In addition, the memory 140 of the chiller 100 may store management data including chiller power consumption information, recommended operation information, current operation information, and product management information, for example. The memory 140 of the chiller 100 may also store diagnostic data including chiller operation information, manipulation information, and error information, for example.

The controller 170 may control the respective units or components in the chiller 100. For example, the controller 170 may control the input 120, the communication device 130, the memory 140, and the drive 220.

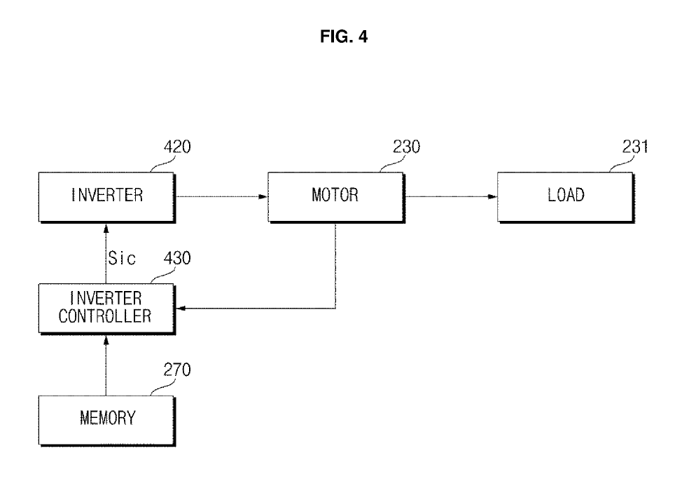

As illustrated in FIG. 2, the drive 220 may include the plurality of drives 220a, 220b, and 220c. Each of the plurality of drives 220a, 220b and 220c may include an inverter 420, an inverter controller 430, and a motor 230 as illustrated in FIG. 4, in order to drive the compressors 11a, 11b and 11c.

The controller 170 may perform control to selectively operate the plurality of drives 220a, 220b and 220c depending on a magnitude of a demanded load 231. More specifically, the controller 170 may perform control to selectively operate inverters 420a, 420b, and 420c within the plurality of drives 220a, 220b, and 220c depending on the magnitude of demanded load.

For example, the controller 170 may perform a control operation to operate only one of the plurality of drives 220a, 220b, and 220c when the magnitude of a demanded load is equal to or less than a first load level, to operate only two of the plurality of drives 220a, 220b, and 220c when the magnitude of a demanded load is equal to or less than a second load level and greater than the first load level, and to operate all of the plurality of drives 220a, 220b and 220c when the magnitude of a demanded load is greater than the second load level. The controller 170 may perform a control operation to operate the respective drives depending on whether the respective switches are turned on.

In particular, the controller 170 may perform a control operation to selectively operate each of the plurality of drives depending on whether a corresponding one of the switches is turned on and depending on the magnitude of a demanded load. More specifically, when some of the switches 120P1, 120P2 and 120P3 are turned on, the controller 170 may perform control to first operate one drive which corresponds to the switch, which has a smaller ID number, among the turned-on switches. Thereafter, when the magnitude of the demanded load increases, that is, when the magnitude of the demanded load is equal to or greater than a capacitance of the drive which is being operated, the controller 170 may perform control to operate the drive which corresponds to another switch.

For example, when the second and third switches 120P2 and 120P3, among the first to third switches 120P1, 120P2, and 120P3, are turned on, the controller 170 may perform control to first operate the second drive 220b which corresponds to the second switch 120P2, which has a smaller ID number than the third switch 120P3. In addition, when the magnitude of the demanded load is equal to or greater than a capacitance of the second drive 220b, the controller 170 may perform control to additionally operate the third drive 220c which corresponds to the third switch 120P3.

In another example, when all of the first to third switches 120P1, 120P2, and 120P3 are turned on, the controller 170 may perform control to first operate the first drive 220a which corresponds to the first switch 120P1, which has the smallest ID number, among the turned-on switches. In addition, when the magnitude of the demanded load is equal to or greater than a capacitance of the first drive 220a, the controller 170 may perform control to additionally operate the second drive 220b which corresponds to the second switch 120P2. Also, when the magnitude of the demanded load is equal to or greater than a capacitance of the first and second drives 220a and 220b, the controller 170 may perform control to additionally operate the third drive 220c which corresponds to the third switch 120P3.

A motor-driving apparatus described in the present application may be a motor-driving apparatus that includes no position sensing unit or sensor, such as a hall sensor, which senses a position of a rotor of a motor, and thus, may estimate the position of the rotor in a sensorless manner. The drive 220 according to an embodiment may be referred to as a motor-driving apparatus 220.

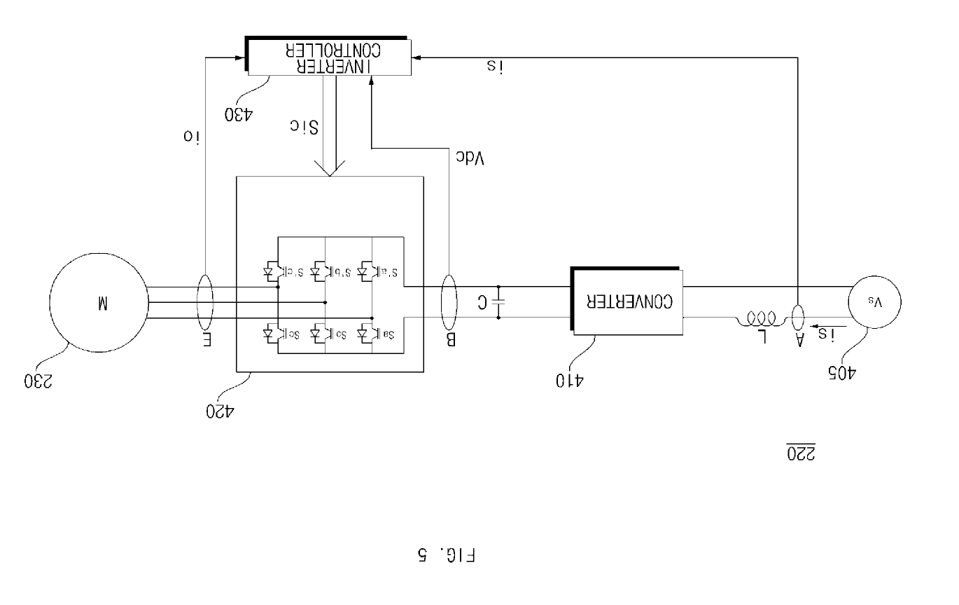

FIG. 4 is an internal block diagram of the motor-driving apparatus in FIG. 3. FIG. 5 is an internal circuit diagram of the motor-driving apparatus in FIG. 4.

Referring to FIGS. 4 and 5, the motor-driving apparatus 220 according to an embodiment may be configured to drive a motor 230 in a sensorless manner, and may include the inverter 420 and the inverter controller 430. In addition, the motor-driving apparatus 220 according to an embodiment may include a converter 410, a dc-terminal voltage detector B, a smoothing capacitor C, and an output current detector E. The motor driving apparatus 220 may further include an input current detector A and a reactor L, for example.

The inverter controller 430 according to an embodiment may perform a control operation to store diagnostic data in the memory 140 or a memory 270 when an error occurs during operation, the diagnostic data including information regarding a time of occurrence of the error, information regarding the operation which was underway when the error occurred, and state information, for example. The inverter controller 430 may perform a control operation to periodically and temporarily store operation information and state information in the memory 140 or the memory 270, and when an error occurs, may perform a control operation to finally store final operation information and final state information, among the periodically and temporarily stored operation information and state information, in the memory 140 or the memory 270.

When an error occurs, the inverter controller 430 may perform a control operation to store information regarding the operation which was underway when the error occurred in the memory 140 or the memory 270, and may perform a control operation to store information regarding the operation or state after a predetermined time has passed since an error occurrence time in the memory 140 or the memory 270. A quantity of data, including the final operation information and the final state information, stored in the memory 140 or the memory 270, may be greater than a quantity of data including information regarding the operation which was underway when the error occurred, or a quantity of data including information regarding the operation or state after a predetermined time has passed since the error occurrence time.

Hereinafter, operations of the respective constituent units or components inside of the motor-driving apparatus 220 in FIGS. 4 and 5 will be described.

The reactor L may be located between a commercial AC power source 405 having a voltage Vs and the converter 410 to perform a power-factor correction and boosting operation. In addition, the reactor L may perform a function for limiting harmonic current by high-speed switching.

The input current detector A may detect input current is from the commercial AC power source 405. A current transformer (CT) or a shunt resistor, for example, may be used as the input current detector A. The detected input current is may be input to the inverter controller 430 as a pulse type discrete signal.

The converter 410 may convert the AC voltage of the commercial AC power source 405, having passed through the reactor L, into a DC voltage. Although a single-phase AC power source is shown as the commercial AC power source 405 in FIG. 5, embodiments are not so limited. That is, a three-phase AC power source may be used, for example. An internal structure of the converter 410 may be changed depending on a type of the commercial AC power source 405.

The converter 410 may include, for example, a diode without a switching element or switch and may perform a rectification operation without performing a separate switching operation. For example, in a single-phase AC power source, four diodes may be used in the form of a bridge. In a three-phase AC power source, six diodes may be used in the form of a bridge.

The converter 410 may be a half bridge converter in which two switching elements or switches and four diodes are connected to one another. In a three-phase AC power source, six switching elements or switches and six diodes may be used. When the converter 410 includes a switching element or switch, a boosting operation, power-factor improvement, and DC voltage conversion may be performed by a switching operation of the switching element or switch.

The smoothing capacitor C may smooth an input voltage and store the smoothed voltage. Although one smoothing capacitor C is illustrated in FIG. 5, a plurality of smoothing capacitors may be included in order to ensure stability.

Although the smoothing capacitor is illustrated in FIG. 5 as being connected to the output terminal of the converter 410, the DC voltage may be directly input to the smoothing capacitor without being limited thereto. For example, the DC voltage from a solar cell may be input to the smoothing capacitor C directly or after DC/DC conversion. Hereinafter, components shown in FIG. 5 will be discussed.

As the DC voltage is stored in the smoothing capacitor C, both terminals of the smoothing capacitor C may be referred to as dc-terminals or dc-link terminals. The dc-terminal voltage detector B may detect a dc-terminal voltage Vdc between the both terminals of the smoothing capacitor C. The dc-terminal voltage detector B may include a resistor or an amplifier, for example. The detected dc-terminal voltage Vdc may be input to the inverter controller 430 as a pulse type discrete signal.

The inverter 420 may include a plurality of inverter switching elements or switches and may convert the dc voltage Vdc smoothed by on/off operation of the switching elements into three-phase AC voltages va, vb and vc having a predetermined frequency and output the three-phase AC voltages to the three-phase synchronous motor 230.

The inverter 420 may include upper-arm switching elements or switches Sa, Sb, and Sc and lower-arm switching elements or switches S′a, S′b, and S′c, each pair of an upper-arm switching element or switch and a lower-arm switching element or switch being connected in series, and three pairs of upper-arm and lower-arm switching elements or switches Sa and S′a, Sb and S′b, and Sc and S′c being connected in parallel. Diodes may be connected in anti-parallel to the respective switching elements or switches Sa, S′a, Sb, S′b, Sc, and S′c.

The switching elements or switches in the inverter 420 may perform on/off operation based on an inverter switching control signal Sic from the inverter controller 430. Thus, the three-phase AC voltages having predetermined frequency may be output to the three-phase synchronous motor 230.

The inverter controller 430 may control a switching operation of the inverter 420 in a sensorless manner. The inverter controller 430 may receive output current io detected by the output current detector E.

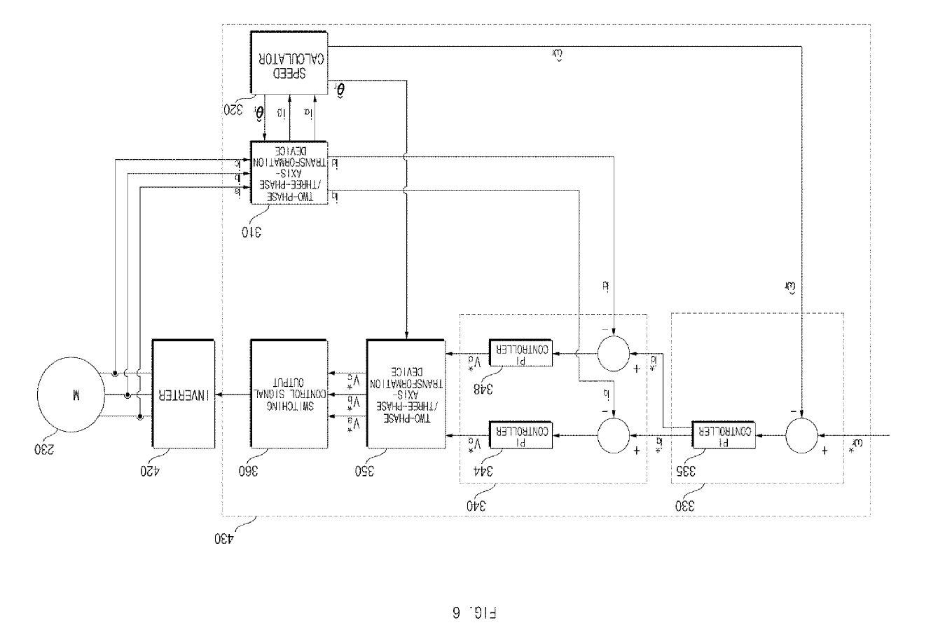

The inverter controller 430 may output the inverter switching control signal Sic to the inverter 420 in order to control the switching operation of the inverter 420. The inverter switching control signal Sic may be generated and output based on the output current io detected by the output current detector E, as a pulse width modulation (PMW) switching control signal. A detailed operation for outputting the inverter switching control signal Sic from the inverter controller 430 will be described hereinafter with reference to FIG. 6.

The output current detector E may detect output current io flowing between the inverter 420 and the three-phase motor 230. That is, the output current detector E may detect current flowing to the motor 230. The output current detector E may detect all of output current ia, ib, and is of respective phases, or may detect two-phase output current based on three-phase balance.

The output current detector E may be located between the inverter 420 and the motor 230, and may be a current transformer or a shunt resistor, for example, in order to detect current. When a shunt resistor is used as the output current detector E, three shunt resistors may be located between the inverter 420 and the motor 230, or may be connected respectively, at one terminal thereof, to three lower-arm switching elements or switches S′a, S′b and S′c. Alternatively, two shunt resistors may be used based on three-phase balance. Alternatively, when a single shunt resistor is used, the corresponding shunt resistor may be located between the above-described capacitor C and the inverter 420.

The detected output current io may be applied to the inverter controller 430 as a pulse type discrete signal, and the inverter switching control signal Sic may be generated based on the detected output current io. Hereinafter, assume that the detected output current io is made up of three-phase output currents ia, ib, and ic.

The three-phase motor 230 may include a stator and a rotor. The AC voltage of each phase, which has a predetermined frequency, may be applied to the coil of the stator of each phase a, b, or c, so as to rotate the rotor.

The motor 230 may include a surface-mounted permanent-magnet synchronous motor (SMPMSM), an interior permanent magnet synchronous motor (IPMSM), and a synchronous reluctance motor (Synrm), for example. The SMPMSM and the IPMSM are permanent magnet synchronous motors (PMSMs) using a permanent magnet, and the Synrm does not include a permanent magnet.

FIG. 6 is an internal block diagram of the inverter controller in FIG. 5. Referring to FIG. 6, the inverter controller 430 may include an axis-transformation unit or device 310, a speed calculator 320, a current command generator 330, a voltage command generator 340, an axis-transformation unit or device 350, and a switching control signal output unit or output 360.

The axis-transformation device 310 may receive detected three-phase current ia, ib, and ic from the output current detector E and transform the three-phase current ia, ib and ic into two-phase current iα and iβ of a stationary coordinate system. The axis-transformation device 310 may transform two-phase current iα and iβ of the stationary coordinate system into two-phase current id and iq of a rotating coordinate system.

The speed calculator 320 may output a calculated position \hat{θ}ᵣ and a calculated speed \hat{ω}ᵣ based on the two-phase current iα and iβ of the stationary coordinate system axis-transformed in the axis-transformation device 310. The current command generator 330 may generate a current command value i*q based on the calculated speed \hat{ω}ᵣ and a speed command value ω*r. For example, the current command generator 330 may perform PI control in a PI controller 335 based on a difference between the calculated speed and the speed command value ω*r and generate the current command value i*q. Although a q-axis current command value i*q is illustrated as the current command value in FIG. 6, a d-axis current command value i*d may also be generated unlike FIG. 6. The value of the d-axis current command value i*d may be set to 0. The current command generator 330 may further include a limiter (not illustrated) that limits a level of the current command value i*q so as not to exceed an allowable range.

Next, the voltage command generator 340 may generate d-axis and q-axis voltage command values v*d and v*q based on the d-axis and q-axis current id and iq axis-transformed into the two-phase rotating coordinate system by the axis-transformation device 310 and the current command values i*d and i*q from the current command generator 330. For example, the voltage command generator 340 may perform PI control in a PI controller 344 based on a difference between the q-axis current iq and the q-axis current command value i*q and generate a q-axis voltage command value v*q. In addition, the voltage command generator 340 may perform PI control in a PI controller 348 based on a difference between the d-axis current id and the d-axis current command value i*d and generate a d-axis voltage command value v*d. The voltage command generator 340 may further include a limiter (not illustrated) that limits a level of the d-axis and q-axis voltage command values v*d and v*q, so as not to exceed an allowable range.

The generated d-axis and q-axis voltage command values v*d and v*q may be input to the axis-transformation device 350. The axis-transformation device 350 may receive the position \hat{θ}ᵣ calculated by the speed calculator 320 and the d-axis and q-axis voltage command values v*d and v*q and performs axis-transformation.

First, the axis-transformation device 350 may transform a two-phase rotating coordinate system into a two-phase stationary coordinate system. At this time, the position \hat{θ}ᵣ calculated by the speed calculator 320 may be used.

Then, the axis-transformation device 350 may transform the two-phase stationary coordinate system into a three-phase stationary coordinate system. Through such transformation, the axis-transformation device 350 may output three-phase output voltage command values v*a, v*b, and v*c.

The switching control signal output 360 may generate and output an inverter switching control signal Sic via a pulse width modulation (PWM) method based on the three-phase output voltage command values v*a, v*b, and v*c. The output inverter switching control signal Sic may be converted into a gate drive signal by a gate driver (not illustrated) and input to the gate of each switching element or switch of the inverter 420. Accordingly, the switching elements or switches Sa, S′a, Sb, S′b, Sc and S′c of the inverter 420 may perform a switching operation.

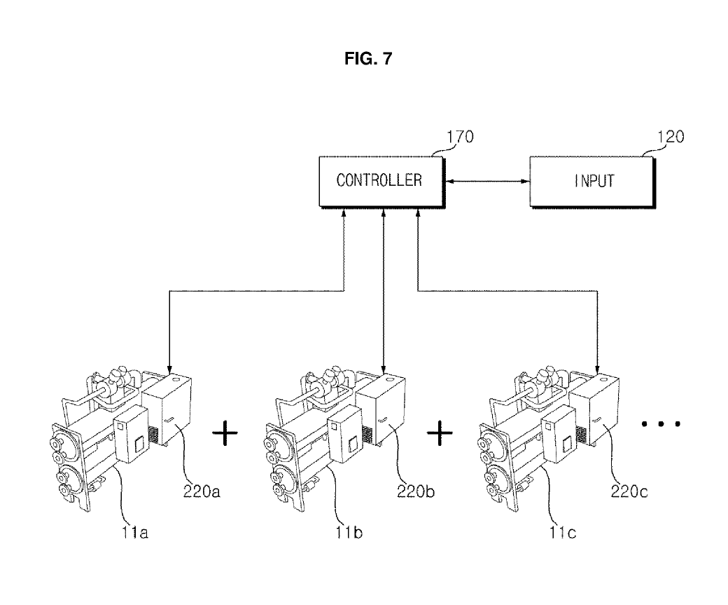

FIG. 7 is a view illustrating a plurality of drives. Referring to FIG. 7, the controller 170 in the chiller 100 may perform control to selectively operate the plurality of drives 220a, 220b and 220c in response to an input signal from the input 120 and depending on a magnitude of a demanded load. More specifically, the controller 170 may perform control to selectively operate the inverters 420a, 420b and 420c in the plurality of drives 220a, 220b and 220c depending on the magnitude of the demanded load.

For example, the controller 170 may perform a control operation to operate only one of the plurality of drives 220a, 220b and 220c when the magnitude of the demanded load is equal to or less than a first load level, to operate only two of the plurality of drives 220a, 220b and 220c when the magnitude of the demanded load is equal to or less than a second load level and greater than the first load level, and to operate all of the plurality of drives 220a, 220b and 220c when the magnitude of the demanded load is greater than the second load level.

The controller 170 may perform a control operation to operate the respective drives depending on whether the respective switches are turned on. In particular, the controller 170 may perform a control operation to selectively operate each of the plurality of drives depending on whether a corresponding one of the switches is turned on and depending on the magnitude of the demanded load.

More specifically, when some of the switches 120P1, 120P2, and 120P3 are turned on, the controller 170 may control one drive which corresponds to the switch, which has the smaller ID number, among the turned-on switches so as to be operated first. Thereafter, when the magnitude of the demanded load increases, that is, when the magnitude of the demanded load is equal to or greater than a capacitance of the drive which is being operated, the controller 170 may perform control to operate the drive which corresponds to another switch.

FIG. 8 illustrates an example of the input in FIG. 3. Referring to FIG. 8, the input 120 may include a dip switch 120a which may be a hardware switch. For example, the input 120 may include a plurality of switches 120P1, 120P2, and 120P3, which may take the form of the dip switch 120a.

The switches 120P1, 120P2, and 120P3 may be first to third switches 120P1, 120P2, and 120P3, to which IDs may be assigned so as to correspond to the first to third drives 220a, 220b and 220c. The respective switches 120P1, 120P2, and 120P3 may be turned on or off by a user's physical force.

FIG. 8 illustrates a state in which only the first switch 120P1, among the first to third switches 120P1, 120P2 and 120P3, is turned on. Embodiments disclosed herein propose a method of stably driving the drives when the magnitude of the demanded load varies in a state in which some of the switches 120P1, 120P2, and 120P3 are turned on.

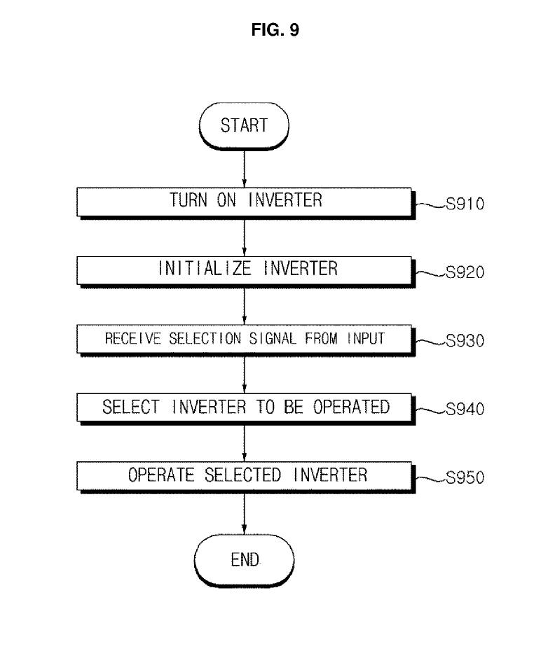

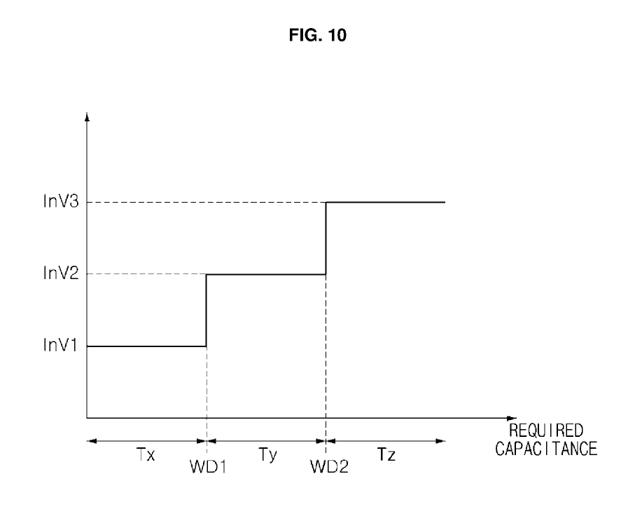

FIG. 9 is a flowchart illustrating a method of operating the chiller according to an embodiment. FIGS. 10 to 12 are views referenced to explain the operating method of FIG. 9.

Referring to FIG. 9, the controller 170 in the chiller 100 may perform a control operation to turn on the inverter 420 in order to operate the chiller 100 in response to a power-on input (S910). Then, the controller 170 in the chiller 100 may perform a control operation to initialize the inverter 420 (S920).

Subsequently, the controller 170 in the chiller 100 may receive a selection signal from the input 120 (S930). The selection signal may be a signal corresponding to the turned-on switch among the switches 120P1, 120P2, and 120P3 in FIG. 8.

Subsequently, the controller 170 in the chiller 100 may select the drive, that is, the inverter, to be operated in response to the selection signal from the input 120 and depending on a magnitude of a demanded load (S940). Then, the controller 170 in the chiller 100 may perform control to operate the selected inverter (S950).

FIG. 10 is a view illustrating operation of a plurality of inverters depending on a magnitude of a demanded load, that is, depending on a required capacitance. The controller 170 in the chiller 100 may perform a control operation to operate only the first drive 220a which corresponds to a first inverter INV1 when a magnitude of a demanded load is equal to or less than WD1, to additionally operate the second drive 220b which corresponds to a second inverter INV2 when the magnitude of the demanded load is greater than WD1 and equal to or less than WD2, and to additionally operate the third drive 220c which corresponds to a third inverter INV3 when the magnitude of the demanded load is greater than WD2.

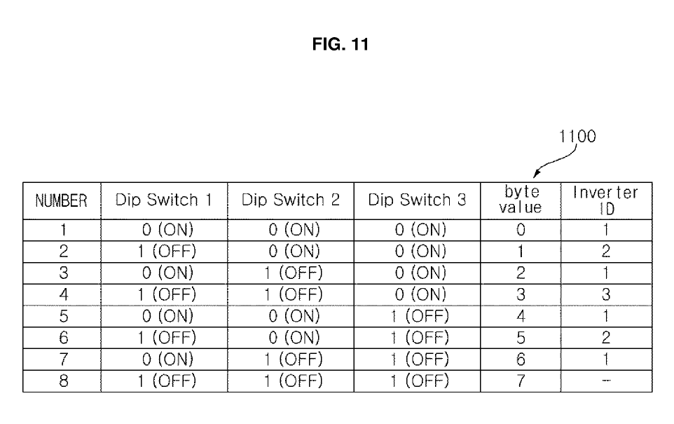

FIG. 11 is a view illustrating assignment of inverter IDs depending on an operation of dip switches. That is, FIG. 11 illustrates the assignment of drive IDs depending on the operation of dip switches.

A table 1100 shows the assignment of inverter IDs depending on the operation of dip switches. The table 1100 may be stored in the memory 140.

Referring to FIG. 11, in the cases of Nos. 4, 6 and 7, in which only one dip switch is operated, an inverter ID which corresponds to the corresponding switch is assigned. In the case of No. 8, in which no dip switches are operated, no inverter ID is assigned.

When multiple dip switches are operated, an inverter ID which corresponds to the switch having a smallest number is assigned. As illustrated in FIG. 11, in the cases of Nos. 2, 3 and 5, in which two dip switches are operated, inverter IDs are respectively assigned to “2”, “1”, and “1”, each of which corresponds to one switch having a number smaller than the other switch. In the case of No. 1, in which all three dip switches are operated, an inverter ID is assigned to “1”, which corresponds to the switch having the smallest number.

For example, when the second and third switches, 120P2 and 120P3, among the first to third switches 120P1, 120P2, and 120P3, are turned on, the controller 170 may perform control to first operate the second drive 220b which corresponds to the second switch 120P2 having a smaller ID number than the third switch 120P3. Then, when the magnitude of the demanded load is equal to or greater than a capacitance of the second drive 220b, the controller 170 may perform control to additionally operate the third drive 220c which corresponds to the third switch 120P3.

In another example, when all of the first to third switches 120P1, 120P2, and 120P3 are turned on, the controller 170 may perform control to first operate the first drive 220a which corresponds to the first switch 120P1 having the smallest ID number among the turned-on switches. Then, when the magnitude of the demanded load is equal to or greater than a capacitance of the first drive 220a, the controller 170 may perform control to additionally operate the second drive 220b which corresponds to the second switch 120P2. Then, when the magnitude of the demanded load is equal to or greater than a capacitance of the first and second drives 220a and 220b, the controller 170 may perform control to additionally operate the third drive 220c which corresponds to the third switch 120P3.

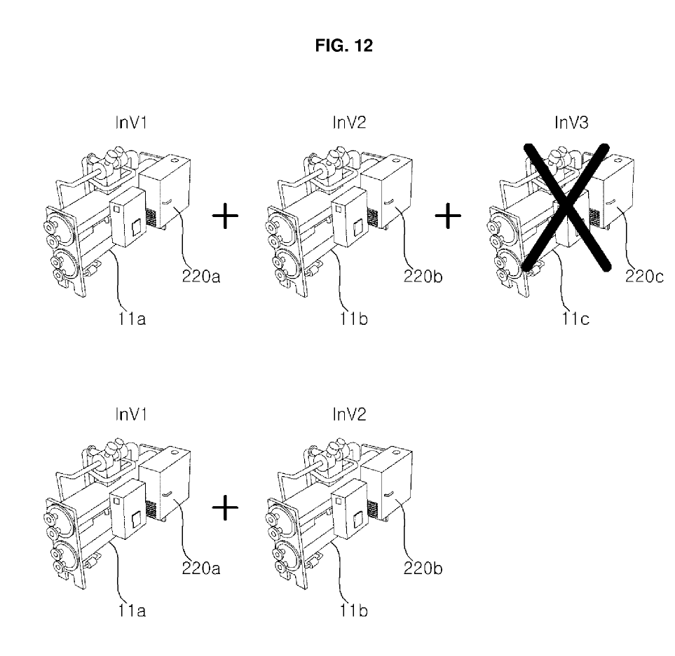

As illustrated in FIG. 12, the three drives 220a, 220b, and 220c may be operated, and then when the magnitude of the demanded load is reduced, only two drives 220a and 220b may be operated. For example, when the magnitude of the demanded load is between WD1 and WD2, as illustrated in FIG. 10, in a state in which all of the switches 120P1, 120P2, and 120P3 are turned on, the controller 170 may perform control to operate only the two drives 220a and 220b.

The controller 170 may perform a control operation to operate all of the three drives 220a, 220b and 220c only after the magnitude of the demanded load exceeds WD2. When the magnitude of the demanded load is within WD1 and WD2, the controller 170 may perform control to operate only two drives 220a and 220b. The controller 170 may perform a control operation to operate only the first and second drives 220a and 220b, which have smaller ID numbers than the third drive 220c, without operating the third drive 220c.

As is apparent from the above description, according to an embodiment, a chiller may include a plurality of compressors, a plurality of drives to drive the compressors, an input having a plurality of switches, to which IDs which correspond to the drives are assigned, and a controller to control the drives. When one or more of the switches is turned on, the controller may perform control to first operate the drive which corresponds to a switch having a smallest ID number, among turned-on switches. Thereby, when the switches are turned on, the compressors may be efficiently and stably driven.

When a magnitude of a demanded load is equal to or greater than a capacitance of the drive which is being driven, the controller may perform control to operate the drive which corresponds to a remaining switch, thereby allowing the compressors to be efficiently and stably driven. The controller may perform control to selectively operate the drives depending on whether the switches are turned on and depending on the magnitude of the demanded load, thereby allowing the drives to be efficiently and stably driven depending on a user's intention and the demanded load.

Embodiments disclosed herein provide a chiller that may include a plurality of compressors, a plurality of drive units or drives to drive the compressors, an input unit or input having a plurality of switches, to which IDs that correspond to the drive units are assigned, and a controller to control the drive units. When all of the switches are turned on, the controller may perform control to first operate a first drive unit that corresponds to a first switch having a smallest ID number among the switches, thereby allowing the compressors to be efficiently and stably driven when the switches are turned on.

The chiller according to embodiments is not limited to configurations and methods of the above-described embodiments, and all or some of the respective embodiments may be selectively combined with one another in order to realize various alterations of the above-described embodiments.

Meanwhile, a chiller operating method according to an embodiment may be implemented as a code which may be written on a processor readable medium, and thus, may be read by a processor included in a motor driving apparatus or home appliance. The processor readable medium may include all kinds of recording devices in which data may be stored in a processor readable manner.

Embodiments disclosed herein provide a chiller which may efficiently and stably drive a plurality of compressors when a plurality of switches is turned on. Embodiments disclosed herein further provide a chiller that may include a plurality of compressors, a plurality of drive units or drives to drive the compressors, an input unit or input having a plurality of switches, to which IDs that correspond to the drive units are assigned, and a controller to control the drive units. When one or more of the switches is turned on, the controller may perform control to first operate the drive unit that corresponds to a switch having a smallest ID number, among turned-on switches.

Embodiments disclosed herein further provide a chiller that may include a plurality of compressors, a plurality of drive units or drives to drive the compressors, an input unit or input having a plurality of switches, to which IDs that correspond to the drive units are assigned, and a controller to control the drive units. When all of the switches are turned on, the controller may perform control to first operate a first drive unit that corresponds to a first switch having a smallest ID number among the switches.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternatives uses will also be apparent to those skilled in the art.

What is claimed is:

1. A chiller, comprising:
a plurality of compressors;
a plurality of drives to drive the plurality of compressors;
an input having a plurality of switches, to which IDs that correspond to the plurality of drive are assigned, respectively; and
a controller to control the plurality of drives, wherein, when one or more of the plurality of switches is turned on, the controller performs control to first operate a drive of the plurality of drives which corresponds to a switch having a smallest ID number, among turned-on switches.

2. The chiller according to claim 1, wherein the controller performs control to operate a drive of the plurality of drives which corresponds to a remaining switch when a magnitude of a demanded load is equal to or greater than a capacitance of the drive which is being driven.

3. The chiller according to claim 1, wherein the plurality of drives include a first drive, a second drive, and a third drive, and wherein, when second and third switches, among first to third switches of the plurality of switches, are turned on, the controller performs control to first operate the second drive which corresponds to the second switch having a smaller ID number than the third switch.

4. The chiller according to claim 3, wherein the controller performs control to additionally operate the third drive which corresponds to the third switch when a magnitude of a demanded load is equal to or greater than a capacitance of the second drive.

5. The chiller according to claim 1, wherein the plurality of drives include a first drive, a second drive, and a third drive, wherein the plurality of switches includes first to third switches, and wherein, when all of the first to third switches are turned on, the controller performs control to first operate the first drive which corresponds to the first switch having a smallest ID number.

6. The chiller according to claim 5, wherein the controller performs control to additionally operate the second drive which corresponds to the second switch when a magnitude of a demanded load is equal to or greater than a capacitance of the first drive.

7. The chiller according to claim 6, wherein the controller performs control to additionally operate the third drive which corresponds to the third switch when the magnitude of the demanded load is equal to or greater than a sum of capacitances of the first and second drives.

8. The chiller according to claim 1, further including a memory to store a table that shows ID assignment depending on an operation of the plurality of switches.

9. The chiller according to claim 8, wherein the memory stores management data including chiller power consumption information, recommended operation information, current operation information, and product management information.

10. The chiller according to claim 1, wherein the plurality of switches include dip switches or tact switches.

11. The chiller according to claim 1, wherein each of the plurality of drives includes:
an inverter including a plurality of switches that covert a direct current (DC) voltage at a dc-terminal into an alternating current (AC) voltage to drive a compressor motor;
an output current detector to detect output current flowing in the motor; and
an inverter controller to output a switching control signal in order to control the inverter based on the output current.

12. The chiller according to claim 11, wherein the controller performs control to selectively operate the inverters in the plurality of drives depending on a magnitude of a demanded load.

13. The chiller according to claim 11, wherein each of the plurality of drives further includes a converter to convert an input AC voltage into a DC voltage and to output the converted DC voltage to the dc-terminal.

14. The chiller according to claim 11, wherein the inverter controller includes:
a speed calculator to calculate a speed of a rotor of a motor based on the output current;
a current command generator to generate a current command value based on the calculated speed and a speed command value;
a voltage command generator to generate a voltage command value based on the current command value and the output current flowing in the motor; and
a switching control signal output to generate and output the switching control signal based on the voltage command value.

15. A chiller, comprising:
a plurality of compressors;
a plurality of drives to drive the plurality of compressors;
an input having a plurality of switches, to which IDs that correspond to the plurality of drives are assigned; and
a controller to control the plurality of drives, wherein, when all of the plurality of switches are turned on, the controller performs control to first operate a first drive of the plurality of drives which corresponds to a first switch having a smallest ID number among the plurality of switches.

16. The chiller according to claim 15, wherein the controller performs control to additionally operate a second drive of the plurality of drives which corresponds to a second switch of the plurality of switches when a magnitude of a demanded load is equal to or greater than a capacitance of the first drive.

17. The chiller according to claim 16, wherein the controller performs control to additionally operate a third drive of the plurality of drives which corresponds to a third switch of the plurality of switches when the magnitude of the demanded load is equal to or greater than a sum of capacitances of the first and second drives.

18. The chiller according to claim 15, further including a memory to store a table that shows ID assignment depending on an operation of the plurality of switches, wherein the memory stores management data including chiller power consumption information, recommended operation information, current operation information, and product management information.

19. The chiller according to claim 15, wherein the plurality of switches include dip switches or tact switches.

20. A chiller, comprising:
a plurality of compressors;
a plurality of drives to drive the plurality of compressors;
an input having a plurality of switches, to which IDs that correspond to the plurality of drive are assigned, respectively; and
a controller to control the plurality of drives, wherein the controller performs control to selectively operate the plurality of drives based on the IDs of turned-on switches of the plurality of switches and a magnitude of a demanded load.
